(19) United States
(12) Patent Application Publication
(10) Pub. No.: US 2022/0371869 A1
(43) Pub. Date: Nov. 24, 2022

(54) PERSON LIFTING AND FALL PROTECTION VEHICLE

(71) Applicant: HUBTEX MASCHINENBAU GMBH & CO. KG, FULDA (DE)

(72) Inventor: JUERGEN KELLER, GROSSENLUEDER (DE)

(73) Assignee: HUBTEX MASCHINENBAU GMBH & CO. KG, FULDA (DE)

(21) Appl. No.: 17/770,629

(22) PCT Filed: Sep. 25, 2020
(86) PCT No.: PCT/EP2020/076934

§ 371 Date: Apr. 21, 2022

(30) Foreign Application Priority Data
Oct. 25, 2019 (DE) 10 2019 128 852.5

(51) Int. Cl. B66F 11/04; B66F 17/00

(52) U.S. Cl. CPC B66F 11/046; B66F 17/006

(57) ABSTRACT

A person-lifting and fall-protection vehicle includes a carrier vehicle having a two-direction vehicle or a multi-direction vehicle, and a person-lifting device having a telescopic boom and a work cage.

### CROSS REFERENCE TO PRIOR APPLICATIONS

This application is a U.S. National Phase application under 35 U.S.C. § 371 of International Application No. PCT/EP2020/076934, filed on Sep. 25, 2020 and which claims benefit to German Patent Application No. 10 2019 128 852.5, filed on Oct. 25, 2019. The International Application was published in German on Apr. 29, 2021 as WO 2021/078470 A1 under PCT Article 21(2).

### FIELD

The present invention relates to a person-lifting and fall-protection vehicle comprising a carrier vehicle and a person-lifting device. The person-lifting device has a telescopic boom and a work cage.

### BACKGROUND

Such a vehicle was previously described in DE 77 11 933 Ul.

A disadvantage of previously described person-lifting and fall-protection vehicles is that they are not suitable for certain conditions of use.

### SUMMARY

An aspect of the present invention is to provide a person-lifting and fall-protection vehicle that is improved with regard to the aforementioned disadvantage.

In an embodiment, the present invention provides a person-lifting and fall-protection vehicle which includes a carrier vehicle comprising a two-direction vehicle or a multi-direction vehicle, and a person-lifting device comprising a telescopic boom and a work cage.

### BRIEF DESCRIPTION OF THE DRAWINGS

The present invention is described in greater detail below on the basis of embodiments and of the drawings in which:

FIG. 1 is a perspective view of an embodiment of the person-lifting and fall-protection vehicle according to the present invention with a raised work cage;

FIG. 2 is a representation like FIG. 1 from a different angle and with a lowered work cage;

FIG. 3 is a schematic perspective view of two lifting- and fall-protection vehicles shown in FIG. 1 during the processing of the upper side of an aircraft; and

FIG. 4 is a schematic perspective view of a lifting- and fall-protection vehicle shown in FIG. 1 during the processing of the upper side of an aircraft.

### DETAILED DESCRIPTION

The carrier vehicle of the person-lifting and fall-protection vehicle according to the present invention comprises a two-direction vehicle or a multi-direction vehicle.

A prerequisite for increased mobility of the person-lifting and fall-protection vehicle and thus suitability for many operating conditions, such as in narrow environments, is thereby created.

The term “two-direction vehicle” in the context of this document refers to a vehicle in which all wheels can be steered. It can, for example, be possible to switch the vehicle from forward travel to sideways travel, for example, by steering all wheels by 90°. All the wheels can, for example, be steerable as desired. The steering pole axis onto which a steering pole is shifted during cornering does not, for example, need run through the axis of two wheels, as in a conventional motor vehicle, but can, for example, run through the center of the vehicle. A particularly tight curve radii can thereby be achieved because all the wheels can be steered during cornering. All the wheels can, for example, be steered so that the vehicle can carry out carousel travel.

The term “multi-direction vehicle” in the context of this document refers to a vehicle that can, for example, from forward travel, be switched to any diagonal travel by steering all the wheels by any equal angle. The multi-direction vehicle can, for example, carry out all driving movements of a two-direction vehicle and driving movements in addition thereto.

A steering program can, for example, be provided that allows the operator to simultaneously set the vehicle in any translational motion, including a curved translational motion, and in any rotation about a pivot point that lies on the vertical axis of the vehicle.

The person-lifting and fall-protection vehicle can, for example, be used to process an object to be processed.

By increasing the mobility of the person-lifting and fall-protection vehicle, a prerequisite can, for example, also be created for the person-lifting and fall-protection vehicle to provide for a traveling production operation. The person-lifting and fall-protection vehicle can thereby be made suitable for operating conditions in which the object to be processed moves. The term “traveling production operation” in the context of this document means an operation in which the person-lifting and fall-protection vehicle automatically follows a moving object to be processed.

The carrier vehicle can, for example, have at least three and particularly, for example, four wheels. All the wheels can, for example, be steerable. A steering motor can, for example, be arranged on each steerable wheel. A first steering motor, a second steering motor, a third steering motor, and a fourth steering motor can therefore, for example, be provided. The steering motors can be hydraulic. The steering motors can, for example, be electric to provide a higher energy efficiency.

All the wheels can, for example, have an angle sensor system. A first steering angle sensor, a second steering angle sensor, a third steering angle sensor, and a fourth steering angle sensor can therefore, for example, be provided. The person-lifting and fall-protection vehicle can, for example, comprise an on-board computer. Steering angle specifications can, for example, be provided via the on-board computer.

The carrier vehicle can, for example, have at least two drive wheels. The carrier vehicle can be equipped with only one drive motor. The carrier vehicle can also be equipped with only one drive wheel. A drive motor can, for example, be arranged on each drive wheel. A first drive motor and a second drive motor can therefore, for example, be provided. Additional drive motors can be provided. The drive motors can be hydraulic. The drive motors can, for example, be electric. Each drive motor can, for example, be speed-controlled. Each drive motor can, for example, receive its speed setting via the on-board computer. Any driving movement can, for example, thereby be carried out sensitively and with high precision.

The carrier vehicle can, for example, include a rechargeable battery with which, for example, the drive motors can be supplied with energy.

The carrier vehicle can, for example, have a running gear. The carrier vehicle can, for example, have a chassis that establishes a connection between the running gear and the roadway. The chassis can, for example, comprise a wheel suspension. In order to increase the stability of the person-lifting and fall-protection vehicle, the chassis can, for example, not be spring-loaded.

The carrier vehicle can, for example, not have pneumatic tires. The stability can thereby be further increased. The carrier vehicle can, for example, have solid rubber tires or polyurethane tires, for example, Vullkollan®.

In the embodiment in which the carrier vehicle has four wheels, the carrier vehicle can, for example, provide a pendulum function of two wheels in order to provide constant ground contact of all the wheels, even on uneven roads, despite the non-spring-loaded chassis, as in a three-wheeled vehicle. The pendulum function can be provided by a pendulum axle. However, for providing the pendulum function, the carrier vehicle can, for example, not have a pendulum axle, but rather a two-part pendulum chassis. The pendulum chassis can, for example, include mechanical leveling. The carrier vehicle can, for example, comprise a blocking device that is configured so that it blocks the pendulum functions if desired in order to further increase the stability of the person-lifting and fall-protection vehicle. The blocking device can, for example, act hydraulically. In one embodiment, the blocking device can, for example, automatically block the pendulum function when the work cage is raised.

The telescopic boom can, for example, be arranged with one end on the carrier vehicle. The work cage can, for example, be attached to the other end of the telescopic boom. As is already known per se, the telescopic boom can, for example, be rotatably arranged on the carrier vehicle. The telescopic boom can, for example, have a turntable therefor. A sensor can, for example, be provided that detects the angle of rotation of the telescopic boom relative to the carrier vehicle. This sensor is also referred to as a “rotation sensor” within the scope of this document.

The telescopic boom can, for example, comprise hydraulic cylinders. To supply the hydraulic cylinders, the person-lifting and fall-protection vehicle can, for example, comprise working hydraulics. The working hydraulics can, for example, comprise a hydraulic pump and a pump motor that drives the hydraulic pump. The pump motor can, for example, be electric.

The work cage can, for example, have an operating region.

The operating region can, for example, have first operating means for controlling the carrier vehicle and can further, for example, comprise second operating means for moving the work cage relative to the carrier vehicle. The carrier vehicle designed as a two-direction or multi-direction vehicle can, for example, also be controlled, for example, steered and/or accelerated, from the operating region of the work cage, for example, even when the work cage is raised by via the telescopic boom. It has surprisingly been shown that the complex steering of a two-direction or multi-direction vehicle is also possible from the work cage and even when the work basket is raised. The first operating means can, for example, include a steering wheel or joystick and/or a driving joystick and/or a driving setpoint generator. The driving setpoint generator can be integrated into the driving joystick. The driving setpoint generator can, for example, comprise a driving speed setpoint generator.

A display can be provided, for example, in the operating region, for example, to display operations that have been carried out.

Third operating means can, for example, be provided on the carrier vehicle via which the movement of the work cage relative to the carrier vehicle can also be operated.

The complete basic operation of the driving movements of the work cage and the working hydraulics can, for example, be operated by via of the second operating means.

The person- and fall-protection vehicle can, for example, have a control device that is operatively connected to the first and second operating means.

As is already known per se, the operating region can, for example, have an enclosing railing and a tread. The term “tread” in the context of this document refers to any structure that a person can step on. The tread can, for example, not have holes or only holes that are so small that a person's foot cannot fit therethrough. The tread can, for example, have no holes or only holes that are so small that no objects can fall therethrough.

The person- and fall-protection vehicle can, for example, be used to allow a person to process a surface to be processed that is located on the object to be processed. The surface to be processed can, for example, be at least largely horizontal. The surface to be processed can, for example, be flat or curved. The surface to be processed can, for example, be at a height that creates a risk of falling for a person. The surface to be processed can, for example, be the upper side of an aircraft.

The work cage can, for example, have a bottom working region that does not have a tread. No other devices can, for example, be provided in the bottom working region that are configured to absorb the weight of a person, in particular while the person is working on the surface. The person in the bottom working region of the work cage can thereby stand directly on an elevated surface to be processed, for example, the upper side of an airplane, and thereby process the surface in a particularly ergonomic manner.

The bottom working region can, for example, be arranged adjacent to the operating region and to, for example, not be movable relative thereto.

The area of the bottom working region can, for example, be at least twice as large as the tread of the operating region. The bottom working region can, for example, have defined boundaries. This can result in particularly effective fall protection.

An access door can, for example, be provided between the operating region and the bottom working region. A locking device can, for example, be provided for locking the access door. The locking device can, for example, work electronically. The locking device can, for example, be configured so that the door is unlocked only in the “safe area,” i.e., directly above the ground or above the surface to be processed.

The work cage can, for example, have fall protection means, which can, for example, be arranged around the bottom working region. The fall protection means can, for example, be configured to secure a person located in the bottom working region against falling. A particularly effective and safety-imparting fall protection, which at most slightly restricts the working person, is achieved if the fall protection means has a railing enclosing the bottom working region. The railing can, for example, enclose the bottom working region directly. It is alternatively conceivable that a tread region is provided adjacent to or around the bottom working region, and that the railing encloses the bottom working region and the tread region together.

The work cage can, for example, be attached to the telescopic boom with its operating region. The operating region is therefore, for example, facing the telescopic boom. The bottom working region can, for example, be turned away from the telescopic boom.

A suitability of the person-lifting and fall-protection vehicle for particularly sensitive environments is achieved if the carrier vehicle and/or the work cage has a collision protection device via which a collision of the carrier vehicle and/or the work cage with surrounding objects and/or people is avoided.

The collision protection device can comprise collision scanners.

The collision protection device of the carrier vehicle can comprise optical sensors. The optical sensors can comprise laser scanners. The laser scanners can comprise rotating laser optics. The laser optics can cover a detection range of 180° or 250° or 270° or 290° or 360°. This can, for example, provide all-around collision protection for the carrier vehicle, which is in particular important for the traveling, i.e., following, production operation. The collision protection device of the carrier vehicle can provide an active environment monitoring. The collision protection device of the carrier vehicle can be configured so that it provides for a simple collision protection and/or navigation and/or full personal protection.

The collision protection device of the work cage can comprise laser scanners, in particular LED laser scanners and, for example, multi-beam LED laser scanners. The laser scanners can, for example, have a detection range of approximately 50° or 70° or 88° or 100° or 120°. The multi-beam LED laser scanners can, for example, deliver a distance value to the control device for each laser beam. An exact positioning of the work cage over a surface to be processed, in particular an aircraft fuselage, is thereby, for example, made possible and collision protection is, for example, provided. The collision protection device of the work cage can, for example, provide horizontal protection of the work cage against collision with surrounding objects and/or people.

A work cage operating assistance device can, for example, be provided which facilitates the operation of the work cage. It can include the collision protection device of the work cage or interact therewith. The work cage operating assistance device can, for example, be configured so that when the work cage vertically approaches the surface to be processed, it automatically slows down the work cage and safely stops the work cage in the end position.

The work cage operating assistance device can be configured so that it allows the work cage to approach and/or be positioned semi-automatically or automatically on the surface to be processed.

The work cage operating assistance device can comprise a line laser which can be arranged on the railing enclosing the bottom working region. The line laser can, for example, not be a sensor. The line laser can be optionally activated, for example, via the display. This can make it easier for the operator of the work cage to position the bottom working region precisely above the surface to be processed. In the middle of the bottom working region, the line laser can project a line onto the surface to be processed located thereunder. The line can be parallel to the operating region of the work cage.

The work cage operating assistance device can, for example, comprise parts of the on-board computer.

The carrier vehicle and/or the work cage can, for example, have a following device that allows for a traveling production operation in which the carrier vehicle and/or the work cage automatically follows a moving object. What can, for example, be thereby achieved is the avoidance of a relative movement between the surface to be processed and the work cage, even when the surface to be processed is located on a moving object. The carrier vehicle and/or the work cage can, for example, follow a moving aircraft production line via the following device. The following device can be integrated into the work cage operating assistance device.

The person-lifting and fall-protection vehicle can, for example, have a crawl device which is configured to optionally allow the carrier vehicle to crawl. The term “crawl” means that the carrier vehicle travels at a constant speed that is below the maximum speed of the carrier vehicle. The maximum speed of the carrier vehicle can, for example, be around two or three or four or five km/h. The crawl device can, for example, automatically maintain the speed of the carrier vehicle when crawling is selected. The speed of the carrier vehicle can then be limited to the maximum speed required for crawling. The crawl device can be configured so that a selected crawl can only be deleted when the driving setpoint generator is in the neutral position. The display can, for example, be configured so that it signals the deletion of a selected crawl.

The display can show the vehicle contour. The display can show the status of elements of the person-lifting and fall-protection vehicle, for example, using symbols. The display can show the angle detected by the rotation sensor. The display can be configured to show a symbol when the telescopic boom has been pivoted past the drive wheels.

A device can be provided which, using the angle detected by the rotation sensor, provides that crawling can only be selected from a previously defined angle. A device can be provided to stop the carrier vehicle from moving as soon as the angle of the rotation sensor exceeds a predetermined value.

The devices of the person-lifting and fall-protection vehicle that are operatively connected to the rotation sensor can in particular be configured via a “teach in.”

The carrier vehicle can have a tilt sensor that detects the tilt angle of the carrier vehicle relative to the horizontal plane. A device can be provided that stops the carrier vehicle from moving when a previously determined tilt angle is exceeded. The stability can thereby be further increased. The display can be configured to show the stop and the cause thereof.

A programmable logic controller can be provided in which one or more of the devices mentioned above is integrated.

A contact-making means can, for example, be provided on the underside of the work cage. The contact-making means can, for example, comprise a flexible material. The contact-making means can, for example, be used to provide that contact is made between the work cage and the surface to be processed in a manner that is gentle on the surface. A collision of the work cage with the surface to be processed, which would damage the surface to be processed, can thereby be avoided and the movement of the work cage relative to the surface to be processed can be avoided while working on the surface. This can also increase the reliability of the fall protection effect of the railing enclosing the bottom working region. This also makes it possible to prevent a swinging of the telescopic boom during the traveling production operation of the person-lifting and fall-protection vehicle. A special protection of the surface to be processed is achieved when the flexible material comprises foam. The contact-making means can, for example, comprise foam buffers. Two foam buffers arranged opposite the bottom working region can, for example, be provided.

The contact-making means can, for example, also allow contact to be made with a curved surface to be processed.

The contact-making means can, for example, comprise a pressure-ensuring device. The pressure-ensuring device can, for example, comprise at least one pressure sensor or work cage placement force sensor on the underside of the work cage. The pressure-ensuring device can, for example, be configured so that it places the work cage on the surface to be processed with a defined contact pressure. A collision of the work cage with the surface to be processed, which would damage the surface to be processed, can thereby be avoided particularly reliably and the movement of the work cage relative to the surface to be processed can be avoided while working on the surface and the fall protection effect of the railing enclosing the bottom working region can be increased.

A hazard to objects and/or persons located below the work cage is reduced if an anti-fall device is provided on the underside of the work cage. The anti-fall device can, for example, prevent small parts, such as tools, from falling down. The anti-fall device can, for example, be arranged in the region of the bottom working region. The anti-fall device can, for example, seal the bottom working region against the surface to be processed. The anti-fall device can, for example, also seal the bottom working region against a curved surface to be processed. Sealing is also achieved in the case of a heavily curved surface to be processed if the anti-fall device comprises a bellows, which can, for example, be circumferential. The bellows can, for example, provide the specified limitation of the bottom working region.

Redundant fall protection can be achieved if fall arresters are provided on the work cage for the maximum number of people allowed in the work cage. The fall arresters can comprise a rope or a harness for connection to a personal safety harness. The fall arresters can comprise a harness that is rolled up like a safety belt. The fall arresters can, for example, be equipped with an electrical contact.

The person-lifting and fall-protection vehicle can, for example, comprise a field bus, for example, a CAN bus. The field bus can, for example, comprise an I/O CAN module that is separate from the on-board computer. The on-board computer can, for example, be connected to the first operating means via the field bus. The on-board computer can, for example, be connected to the second operating means via the field bus. The on-board computer can, for example, be connected to the tilt sensor via the field bus. The on-board computer can, for example, be connected to the first steering angle sensor and/or to the second steering angle sensor and/or to the third steering angle sensor and/or to the fourth steering angle sensor and/or to the rotation sensor via the fieldbus. The on-board computer can, for example, be connected to the first drive motor and/or to the second drive motor and/or to the pump motor and/or to the first steering motor and/or to the second steering motor and/or to the third steering motor and/or to the fourth steering motor via the field bus.

The person-lifting and fall-protection vehicle can, for example, have a data acquisition system. The data acquisition system can, for example, make data of the person-lifting and fall-protection vehicle accessible, for example, individual data or all of the data detected by the sensors of the person-lifting and fall-protection vehicle. The data can, for example, be made accessible via a local wireless network, such as WLAN.

The present invention will now be described in greater detail below under reference to the accompanying drawings.

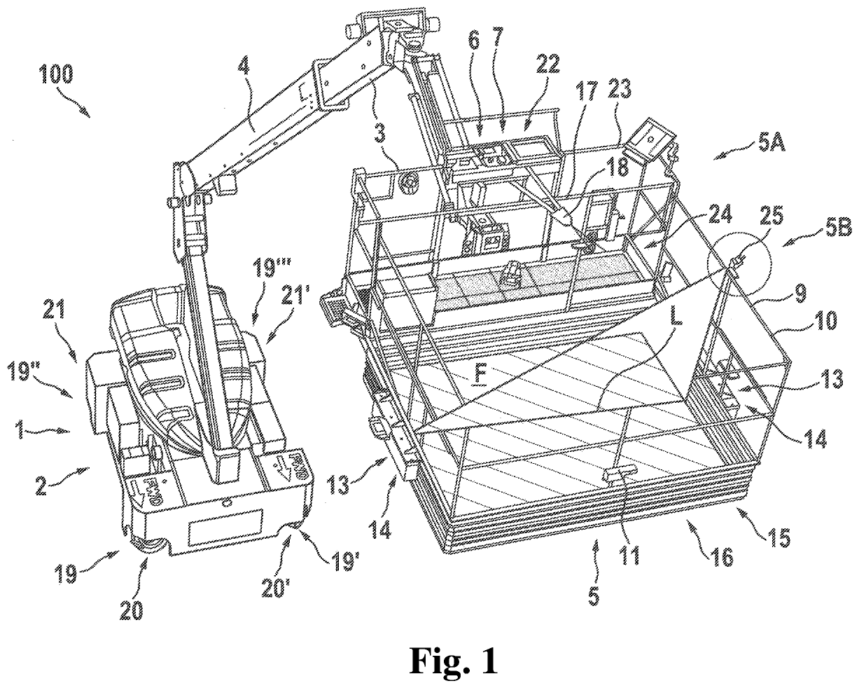

The person-lifting and fall-protection vehicle, which is designated as a whole with 100 in FIG. 1, comprises a carrier vehicle 1 and a person-lifting device 3. The person-lifting device 3 has a telescopic boom 4 and a work cage 5. The carrier vehicle 1 is designed as a multi-direction vehicle 2.

The person-lifting and fall-protection vehicle 100 is used to process an object to be processed, more precisely, an at least substantially horizontal surface to be processed that is located on an object to be processed, specifically, the upper side of an aircraft.

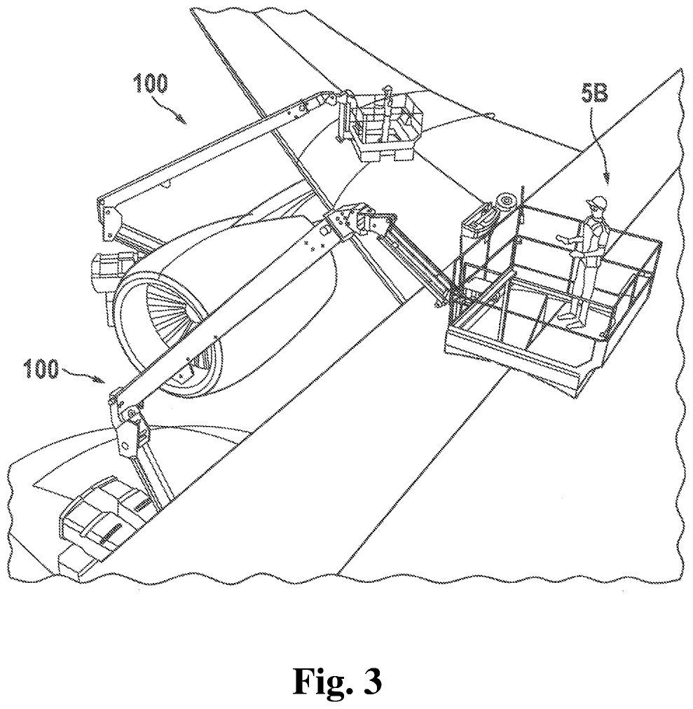

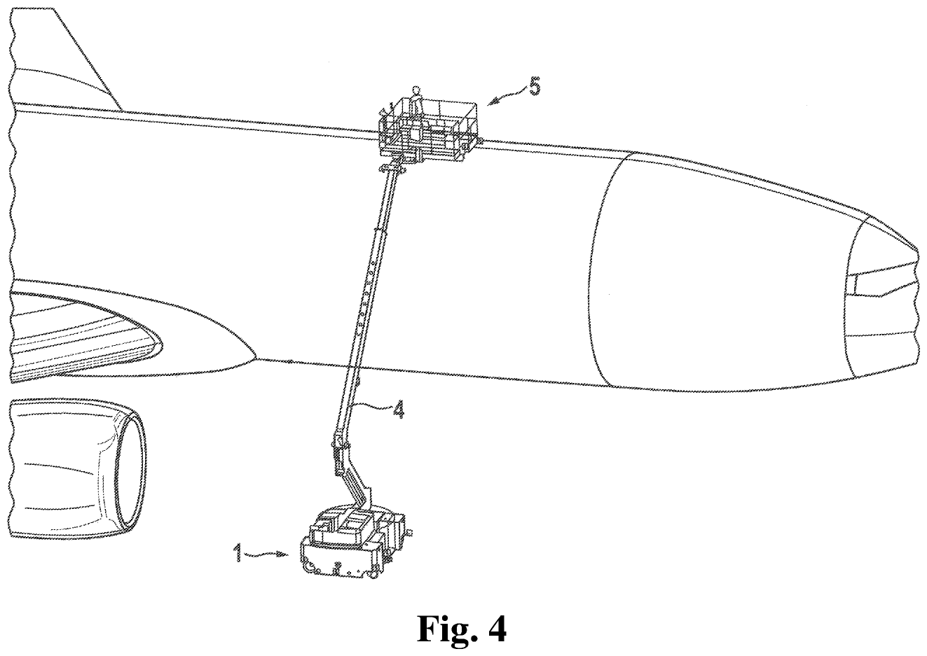

FIGS. 3 and 4 show a traveling production operation. The aircraft shown are part of a moving aircraft production line that the person-lifting and fall-protection vehicle 100 automatically follows.

The carrier vehicle 1 has four steerable wheels 19, 19′, 19″, 19′″ having solid rubber tires. A steering motor is arranged on each of the four wheels 19, 19′, 19″, 19′″.

All wheels 19, 19′, 19″, 19′″ have angle sensor systems. Steering angle specifications are made via an on-board computer.

The carrier vehicle has two drive wheels 20, 20′, each of which have an electric drive motor.

The carrier vehicle 1 uses a two-part pendulum chassis to provide a hydraulically lockable pendulum function of two wheels 21, 21′ via mechanical leveling to provide constant ground contact of all wheels 19, 19′, 19″, 19′″ despite the non-spring-loaded chassis, as with a three-wheeled vehicle.

The telescopic boom 4 is rotatably arranged with one end on the carrier vehicle 1 and with the other end on the work cage 5. A rotation sensor is provided to detect the rotation angle of the telescopic boom 4 relative to the carrier vehicle 1.

The telescopic boom 4 comprises hydraulic cylinders for the supply of which a hydraulic pump and an electric pump motor that drives the hydraulic pump are provided.

The work cage 5 has an operating region 5A and a bottom working region 5B. The operating region 5A has first operating means 6 for controlling the carrier vehicle 1 and a second operating means 7 for moving the work cage 5 relative to the carrier vehicle 1. The first operating means 6 comprise a steering wheel and a driving joystick and a driving speed setpoint generator.

A display 22 is provided in the operating region 5A, i.e., for displaying any operations carried out.

The person- and fall-protection vehicle 100 has a control device that is operatively connected to the first and second operating means 6, 7.

Third operating means (which is not shown in detail in the drawings) are provided on the carrier vehicle 1 via which the movement of the work cage 5 relative to the carrier vehicle 1 can also be operated.

The operating region 5A has an enclosing operating region railing 23 and a tread 24.

The bottom working region 5B has no tread and no other devices are provided in the bottom working region 5B that are configured to absorb the weight of a person, in particular while the person is working on the surface. The person in the bottom working region 5B of the work cage 5 can therefore stand directly on an elevated surface to be processed, for example, the upper side of an airplane, as shown in particular in FIG. 3, and thereby process the surface in a particularly ergonomic manner.

The bottom working region 5B is arranged adjacent to the operating region 5A and is not movable relative thereto. The bottom working region 5B is separated from the operating region 5A by an access door 17.

The area F of the bottom working region 5B, which is hatched in FIG. 1 and defined by fixed boundaries, is at least twice as large as the tread 24 of the operating region 5A.

FIG. 1 shows that the operating region 5A faces the telescopic boom 4 and that the bottom working region 5B faces away from the telescopic boom 4.

An electronic locking device is provided for locking the access door 17, which unlocks the access door 17 only in the “safe area,” i.e., directly above the ground or above the surface to be processed.

The work cage 5 has fall protection means 9 that are arranged around the bottom working region 5B and are configured to secure a person in the bottom working region 5B against falling. The fall protection means 9 have a railing 10 directly enclosing the bottom working region 5B.

The carrier vehicle 1 and the work cage 5 have a collision protection device 11 that comprises collision scanners.

The collision protection device 11 of the carrier vehicle 1 provides an active environment monitoring and comprises optical sensors in the form of laser scanners having rotating laser optics and a 270° detection range. It can be configured to provide a simple collision protection and/or navigation and/or full personal protection.

The collision protection device 11 of the work cage 5 comprises multi-beam LED laser scanners having a detection range of 88°. These multi-beam LED laser scanners deliver a distance value to the control device for each laser beam. This allows, for example, an exact positioning of the work cage 5 over an aircraft fuselage to be processed and collision protection is be provided. The collision protection device 11 of the work cage 5 provides for the horizontal protection of the work cage 5 against collision with surrounding objects, in particular an aircraft.

A work cage operating assistance device is provided to facilitate the operation of the work cage 5. The work cage operating assistance device is configured so that, when the work cage 5 vertically approaches, for example, the upper side of an aircraft, it automatically slows down the work cage 5 and safely stops the work cage 5 in the end position. The work cage operating assistance device is configured so that it allows the work cage 5 to semi-automatically or automatically approach the aircraft upper side.

The work cage operating assistance device comprises a line laser 25 which is arranged on the railing 10 and projects a line L running parallel to the operating region 5A in the center of the bottom working region 5B, for example, onto the upper side of an aircraft below.

The carrier vehicle 1 has a following device which allows the traveling production operation shown in FIGS. 3 and 4, in which the carrier vehicle 1 automatically follows the moving aircraft.

The person-lifting and fall-protection vehicle 100 has a crawl device which is configured to optionally allow the carrier vehicle 1 to crawl.

The display 22 can show the vehicle contour. The display 22 uses symbols to show the status of elements of the person-lifting and fall-protection vehicle and shows the angle detected by the rotation sensor. It is configured to show a symbol when the telescopic boom 4 has been pivoted beyond the drive wheels 20, 20′.

The carrier vehicle 1 has a tilt sensor that detects the tilt angle of the carrier vehicle 1 relative to the horizontal plane. A device is provided that stops the carrier vehicle 1 from moving when a previously determined tilt angle is exceeded.

A programmable logic controller is provided in which one or more of the devices mentioned above is integrated.

As FIG. 1 shows, a contact-making means 13 is provided on the underside of the work cage 5. The contact-making means 13 comprises flexible material 14, and specifically two foam buffers which are arranged opposite the bottom working region 5B.

The contact-making means 13 comprises a pressure-ensuring device (which is not shown in detail in the drawings) that is configured so that it places the work cage 5 on the upper side of the aircraft with a defined contact pressure.

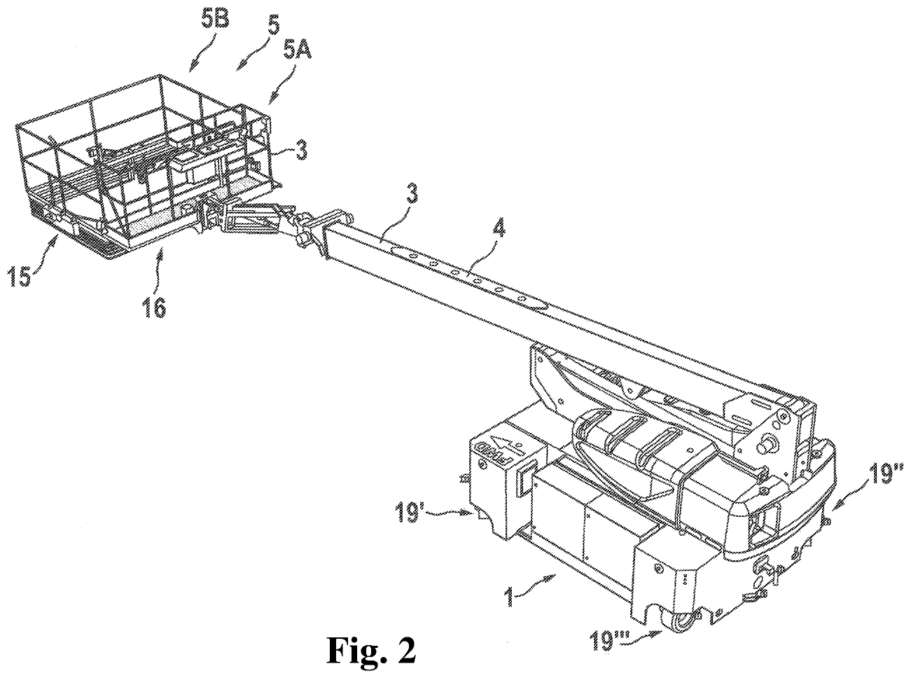

As shown in FIGS. 1 and 2, an anti-fall device 15 comprising a bellows 16 is provided on the underside of the work cage 5.

A fall arrester 18 is provided on the work cage 5, which fall arrester 18 comprises a belt rolled up like a safety belt for connection to a personal safety harness (which is not shown in the drawings).

The present invention is not limited to embodiments described herein; reference should be had to the appended claims.

### LIST OF REFERENCE SIGNS

100 Person-lifting and fall-protection vehicle
1 Carrier vehicle
2 Multi-direction vehicle
3 Person-lifting device
4 Telescopic boom
5 Work cage
5A Operating region
5B Bottom working region
6 First operating means
7 Second operating means
9 Fall protection means
10 Railing
11 Collision protection device
13 Contact-making means
14 Flexible material
15 Anti-fall device
16 Bellows
17 Access door
18 Fall arrester
19, 19′, 19″, 19′″ Wheels
20, 20′ Drive wheels
21, 21′ Swinging wheels
22 Display
23 Operating region railing
24 Tread
25 Line laser
F Area of the bottom working region
L Line of the line laser

What is claimed is:

1-10. (canceled)

11: A person-lifting and fall-protection vehicle comprising:
a carrier vehicle comprising a two-direction vehicle or a multi-direction vehicle; and
a person-lifting device comprising a telescopic boom and a work cage.

12: The person-lifting and fall-protection vehicle as recited in claim 11, wherein the work cage comprises an operating region which comprises a first operating means for controlling the carrier vehicle, and a second operating means for moving the operating region relative to the carrier vehicle.

13: The person-lifting and fall-protection vehicle as recited in claim 12, wherein the work cage further comprises a bottom working region which does not comprise a tread or any other device in the bottom working region which can absorb a weight of a person.

14: The person-lifting and fall-protection vehicle as recited in claim 13, wherein the work cage further comprises,
an access door which is arranged between the operating region and the bottom working region, and
a locking device which is configured to lock the access door.

15: The person-lifting and fall-protection vehicle as recited in claim 13, wherein the work cage further comprises a fall protection means which is configured to secure the person in the bottom working region against a fall, the fall protection means comprising a railing which encloses the bottom working region.

16: The person-lifting and fall-protection vehicle as recited in claim 11, wherein at least one of the carrier vehicle and the work cage further comprises/comprises a collision protection device which is configured to avoid a collision of at least one of the carrier vehicle and the work cage with at least one of a surrounding object and a person.

17: The person-lifting and fall-protection vehicle as recited in claim 11, wherein at least one of the carrier vehicle and the work cage further comprises/comprises a following device which is configured to provide for a traveling production operation where at least one of the carrier vehicle and the work cage automatically follows a moving object.

18: The person-lifting and fall-protection vehicle as recited in claim 11, wherein the work cage comprises a contact-making means which is arranged on an underside of the work cage, the contact-making means comprising a flexible material.

19: The person-lifting and fall-protection vehicle as recited in claim 11, wherein the work cage comprises an anti-fall device which is arranged on an underside of the work cage, the anti-fall device comprising a bellows.

20: The person-lifting and fall-protection vehicle as recited in claim 11, wherein the work cage comprises a fall arrester for each of a maximum number of people in the work cage.
